(19) United States
(12) Patent Application Publication
(10) Pub. No.: US 2009/0164111 A1
(43) Pub. Date: Jun. 25, 2009

(54) Navigation apparatus and program

(75) Inventors: Yasuki Hosoi, Okazaki-shi (JP); Tominori Iwata, Okazaki-shi (JP); Shougo Matsuhisa, Okazaki-shi (JP)

Correspondence Address: BACON & THOMAS, PLLC, 625 SLATERS LANE, FOURTH FLOOR, ALEXANDRIA, VA, 22314-1176, US

(73) Assignee: AISIN AW CO., LTD., Anjo-shi (JP)

(21) Appl. No.: 12/292,914

(22) Filed: Dec. 1, 2008

(30) Foreign Application Priority Data
Dec. 25, 2007 (JP) 2007-332407

(51) Int. Cl. G01C 21/34

(52) U.S. Cl. 701/200

(57) ABSTRACT

A navigation apparatus for searching for a route from a place of departure to a destination includes an information storage unit storing map data in a hierarchical structure, a route-searching unit for retrieving the map data from the information storage unit, searching for a route within a predetermined area on the departure side and on the destination side, and obtaining a route with the lowest cost in the range of overlapped search areas, and a control unit for controlling the search by the route-searching unit. The control unit updates the registered cost for the lowest cost route when the cost of the route of lowest cost obtained by searching up to a higher level within the hierarchy is smaller than that previously registered cost.

### INCORPORATION BY REFERENCE

The disclosure of Japanese Patent Application No. 2007-332407 filed on Dec. 25, 2007, including the specification, drawings and abstract thereof, is incorporated herein by reference in its entirety.

### BACKGROUND

1. Field of the Invention

The present invention relates to a navigation apparatus and a program for maintaining quality while reducing the time required for route-searching.

2. Description of the Related Art

When searching for a route in a navigation system, various costs are respectively set for the various links and/or nodes of potential routes, depending on road type such as an expressway, a toll road, a national road, a main local road, a state (or prefecture) road, or narrow street, the existence of traffic restrictions such as no-turn or one-way traffic, link length, a width of a road, number of traffic lanes, and so forth. When searching for an optimum route from the current location of the host vehicle to a destination, a route is searched both from the departure point (current location) and from the destination along links stored in map data. A cumulated cost calculated starting from the departure point and a cumulated cost calculated starting from the destination are added for a length of the route overlapped by the searches from the departure point and from the destination. Then, a route with a lowest value for the sum of the costs determined by the searches from both ends is set as an optimum guidance route.

Japanese Unexamined Application Publication (“kokai”) No. 4-301515 discloses a hierarchical search method using map data having a hierarchical structure. In the map data with a hierarchical structure, a lower level hierarchical layer contains the most detailed map data, including data for every road, and an upper level hierarchical layer contains area-wide map data limited to data for main roads only. In the hierarchical searching method, a cost is calculated using the detailed map data for the vicinity of the departure point and the destination, a calculation is briefly made using rougher map data for an intermediate length of a route, and a guidance route (optimum) is determined (set) by combining the results. In using such a hierarchical search method, when the distance between the point of departure and the destination is long, an intermediate portion of the route can be searched by using the rough (less detailed) map data; therefore, the overall time necessary for the route-searching can be reduced as compared to a search of an entire route using detailed map data throughout.

Japanese Unexamined Application Publication (“kokai”) No. 11-257987 discloses a method for faster determination of an optimum route, in which, when a route with lowest cost is determined by using lower level hierarchical map data, the route-searching is terminated at that time and upper level hierarchical map data is not searched. In FIG. 10(a), for example, a predetermined area is searched at the current location (departure point) and at the destination, each search using a hierarchical layer 1 including the detailed map data. Then a boundary node SN11 having the smallest search cost is searched for in the area in layer 1 predetermined for the departure point and a boundary node DN11 having the smallest search cost is searched for in the area in layer 1 predetermined for the destination side. Then, the searches move to nodes SN21 and DN21 corresponding to these boundary nodes in hierarchical layer 2, i.e. route-searching is performed using the hierarchical layer 2. When a route searched from the departure end connects with a route searched from the destination end and the two overlap on the hierarchical layer 2, a route P1 becomes an optimum route.

### SUMMARY

With the above-described conventional route-searching method, however, when combining the hierarchical map data and the route-searching algorithm, the algorithm of Kokai 11-257987 for reducing the time required for route-searching does not guarantee that the route P1 obtained by the route search will be the optimum route in terms of quality. In FIG. 10(b), for example, there is a boundary node SN12 at the boundary of the area in layer 1 predetermined for the departure point and a boundary node DN12 at the boundary of the area in layer 1 predetermined for the destination point, for which the cost to reach the boundary of that area on layer 1 is not the smallest. In a search wherein nodes SN22 and DN22 on the layer 2 corresponding to these boundary nodes (SN12 and DN12) are the starting points for searching layer (level) 2, nodes SN23 and DN23 are found to have the lowest cost to reach the boundaries of the predetermined areas on the departure side and the destination side, respectively, in layer 2. In a search of layer 3, wherein nodes SN31 and DN31 are the starting points corresponding to the nodes SN23 and DN23, a route P2 is found. There is the possibility that the cost for route P2 is smaller than the cost for route P1. If the cost of the route P2 is smaller, it is deemed to be a more preferred route than route P1 in terms of quality. That is, finding a route that connects a departure and a destination as fast as possible by using map data with a hierarchical structure does not mean that the optimum route in terms of time and quality, i.e. the route with the smallest cost, can be set as the guidance route. For example, there is the possibility that a route including a winding mountain road or the like will be set as the guidance route. Fundamentally, the relationship between shortening the time for searching for the route and the quality of the route found thereby is inversely proportional. Therefore, it has been very difficult to perform a fast and also high-quality route-search.

Accordingly, it is an object of the present invention to provide a navigation apparatus that maintains the quality of route-searching in terms of the route located and at the same time reduces the time of the route-search.

Accordingly, the present invention provides a navigation apparatus for searching for a route from a departure location to a destination, the apparatus including: an information storage unit that stores map data, the map data being structured in hierarchical layers; a route-searching unit that reads out map data from the information storage unit, searches for a route within areas predetermined for each of the departure location and destination on one hierarchical level, and obtains a route with a lowest cost in a range defined by overlapping of the search areas (merging of the searches from the departure and destination sides); and a control unit that controls the searching by the route-searching unit; wherein the control unit updates a cost previously registered (stored) for a route with the lowest cost when a cost of a route with a lowest cost obtained by searching from a lower hierarchical layer up to an upper level hierarchy is lower than the cost of a previously obtained route.

In addition, the present invention provides a navigation apparatus comprising:

an information storage unit that stores road information structured in hierarchical layers with different levels of detail;

a route-searching unit that searches for the guidance route to a destination on the basis of the road information stored in the information storage unit; and

a control unit that judges quality of the guidance route determined by the route-searching unit and controls execution of a route-searching routine;

wherein the route-searching unit searches a range of a predetermined area of a departure place and a destination using detailed data of a lower hierarchical level (data level) and moves to an upper hierarchical level to continue route-searching after searching the predetermined range in the lower hierarchical level; and

the control unit compares the cost of a route obtained by search in an upper hierarchical data level and a cost of a route obtained by search in a lower hierarchical data level when a route has been obtained which connect the starting point (place of departure) and the destination, and terminates the route-searching routine responsive to a judgment that a cost of a route obtained by search in a lower hierarchical level is lower than the cost of a route obtained by search within an upper hierarchical level.

Further, the present invention provides a program for controlling a computer of a navigation apparatus that searches for a route from a place of departure to a destination, which causes the computer to execute the steps of:

reading out map data from an information storage unit, the map data being structured in hierarchical layers;

searching for a route within a predetermined area of each of departure side and destination side and obtaining a route with a lowest cost in a range overlapped by the searches; and

updating a previously registered cost for a route with the lowest cost when a cost of a route with a lowest cost obtained by searching up to an upper hierarchical level is smaller than the cost registered for the previously obtained route of lowest cost.

Accordingly, it is possible to maintain a high quality for the route obtained by route-searching and at the same time reduce the time necessary for the route-searching.

### BRIEF DESCRIPTION OF THE DRAWINGS

Preferred embodiments of the present invention will now be described with reference to the accompanying drawings, wherein:

FIG. 1 is a block diagram of a preferred embodiment of a navigation system according to the present invention;

FIG. 2 is a schematic outline of a route-searching and cost-marking routine;

FIG. 3 is a flowchart of a route-searching routine;

FIGS. 4A and 4B respectively show search starting point areas on the departure side and the destination side;

FIG. 5 is a flowchart of a search routine using the Dijkstra method;

FIG. 6 is a diagram showing cost-marking of nodes on one search hierarchical level;

FIG. 7 is a flowchart of a subroutine for route-searching termination judgment (S110 in FIG. 3);

FIG. 8 is a flowchart of a subroutine for cost-marking to an upper hierarchical level (S112 in FIG. 3);

FIG. 9 is a schematic outline of cost-marking to an upper hierarchical level; and

FIGS. 10A and 10B are schematic outlines of route-searching using map data having a hierarchical structure.

### DESCRIPTION OF THE PREFERRED EMBODIMENTS

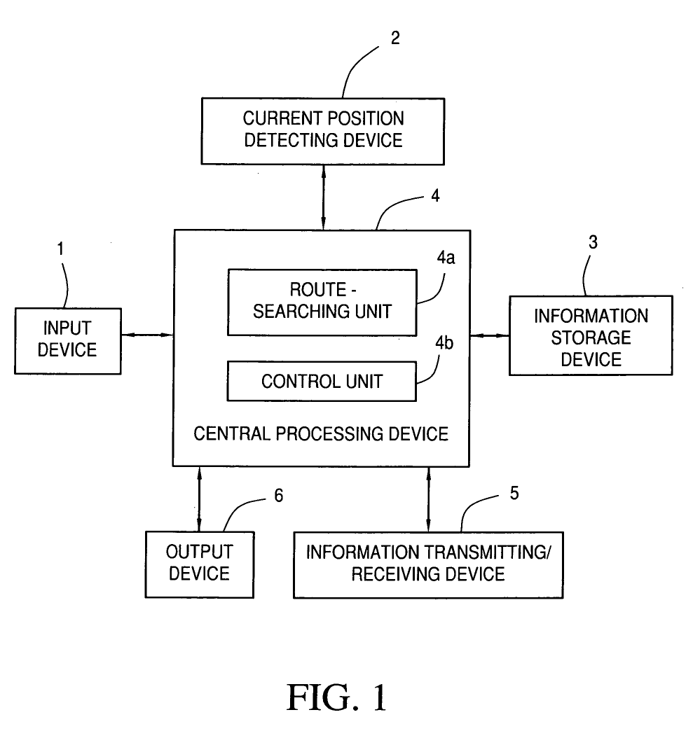

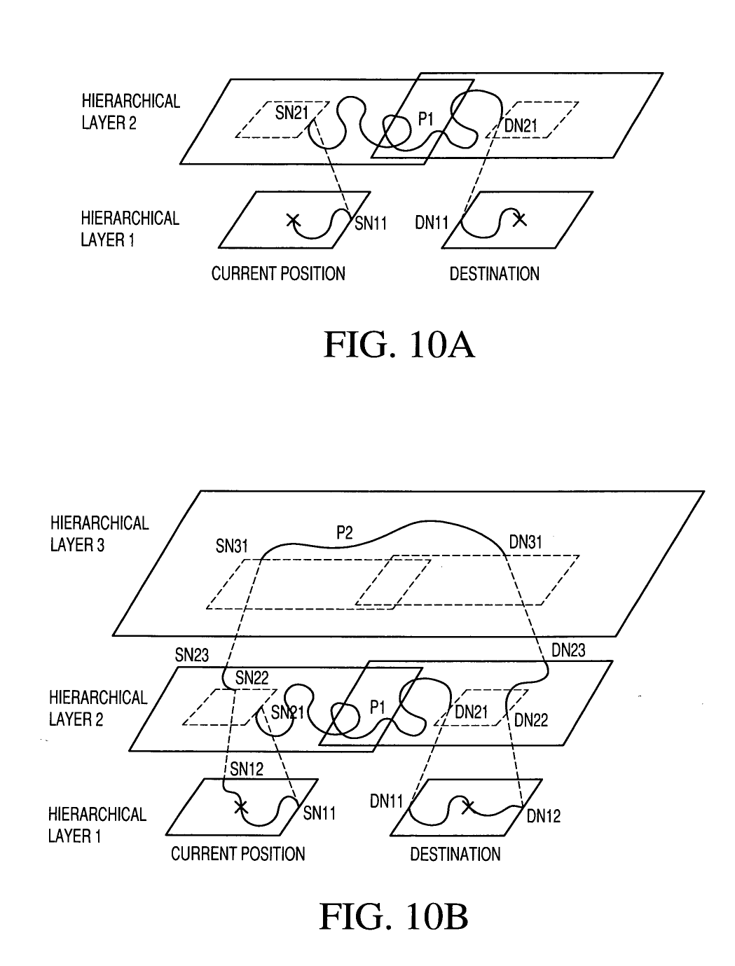

A preferred embodiment will now be described with reference to FIGS. 1 through 10. As shown in FIG. 1, a navigation system comprises an input device 1 including a keyboard, a mouse, a touch panel, an operation key, and so forth for inputting information for a place of departure (departure location) or a destination, a current location detecting device 2 for detecting information regarding a current location, an information storage unit 3 for storing map data with a hierarchical structure of layers, in which each of the hierarchical layers has a plurality of blocks, intersection data, navigation data for route-searching, display/voice guidance data for output of route guidance, a program for outputting guidance such as a map display, route-searching, voice guidance, and so forth (an application and/or OS), a central processing unit 4, an information transmitting/receiving device 5 that transmits/receives information regarding vehicle travel such as road information and/or traffic information, detects information regarding the current location of the vehicle, and also transmits/receives information regarding the current location, and an output device 6 such as a display, a speaker, or the like that outputs information as route guidance.

The central processing unit 4 includes a route-searching unit 4a for reading out the map data, for searching for a route within a predetermined area on both the departure side and the destination side, and for obtaining a guidance route with the lowest cost within an overlapped search area; and a control unit 4b for judging the quality of the guidance route located by the route-searching unit by comparing costs, for controlling execution of the search routine by the route-searching unit, for executing a map display routine functioning as a navigator processing unit, for display/voice guidance processing necessary for route guidance, and for overall control of the entire navigation system.

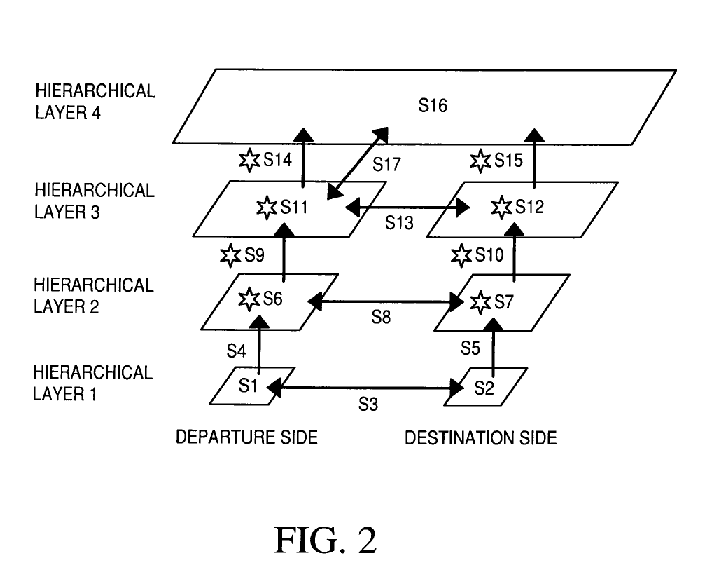

FIG. 2 is a schematic outline illustrating route-searching and cost-marking. As shown in FIG. 2, the present embodiment uses map data having a four layer hierarchical structure. The map data includes a hierarchical structure having a plurality of blocks of data of predetermined area in each layer. A lower hierarchical level includes detailed map data with data for every road and an upper hierarchical level includes area-wide map data limited to data for main roads only. First, a route is searched in a predetermined area on the departure side and on the destination side by using detailed map data within hierarchical layer 1 (Steps S1 and S2). If the routes searched in the each of the areas meet (or overlap), a cost is obtained as a route with a shortest cost (Step S3). Next, the searching progresses to boundary nodes in layer 2 corresponding to the boundary nodes that have been reached on each area searched in layer 1 (Steps S4 and S5). Then, each of the boundary nodes in layer 2 is set as starting points for searching for a guidance route and the reached cost for each node, i.e. the cost to reach that node, is stored (The stars in the figure indicate that a cost is stored). If the routes searched in the areas of the departure side and the destination side connect (“meet” or “overlap”) on the layer 2 and the cost of the connected route is smaller than the cost of the route with the smallest cost obtained in the searching of layer 1, the stored cost for the route with the lowest cost is updated (Step S8). Thereafter, likewise, when a route is searched in each of the departure side and the destination side areas in the layer 3 and the routes determined for the areas connect and the cost of the connected route is also smaller than the cost of the route with the lowest cost obtained in the lower hierarchical level, the stored cost of the route with the lowest cost is updated and the procedure moves to the uppermost hierarchical level 4 (Steps S9 to S15). In the uppermost level 4, the routes from the departure and destination sides must be connected; therefore, a search is executed from the destination side only (Step S16) and, if the cost of the route obtained in the uppermost level 4 is lower than the cost of the route with the lowest cost obtained for the lower levels, the cost of the route with the lowest cost is updated (Step S17). As described above, the quality (cost) of the obtained route is optimized by continuing a search on each hierarchical level until the guidance route with lowest cost is defined. In addition, if the cost to search a node in a hierarchical level is found to be bigger than the stored cost of the route with the lowest cost, no further cost-marking will be executed for a node in that level. At the same time, when moving to an upper level hierarchy, if the sum of the lowest cost to reach a boundary node on the departure side and a boundary node on the destination side is higher than the cost of the stored route with the lowest cost, the route-searching will be terminated for that level, whereby the time for searching can be reduced.

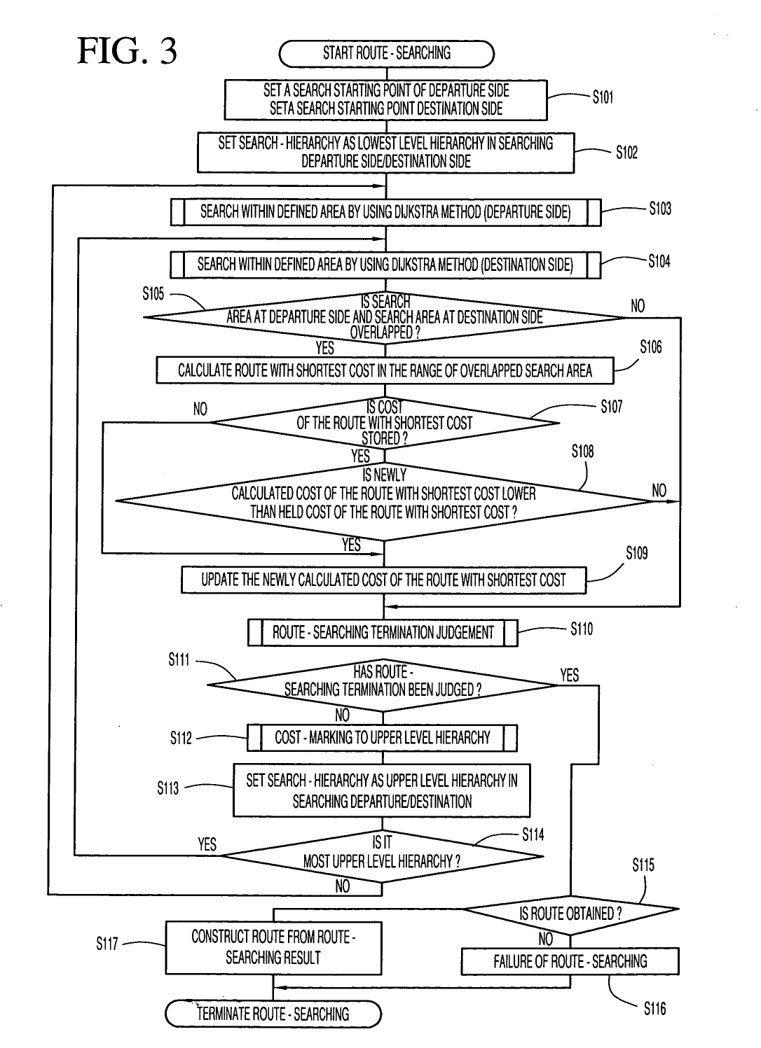

FIG. 3 is a flowchart illustrating the entire route-searching routine.

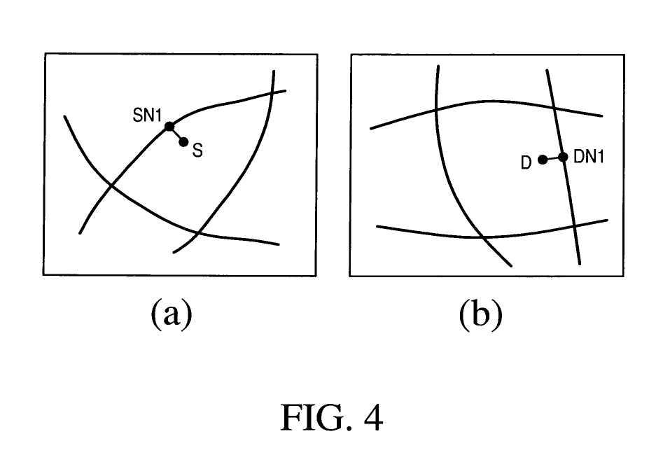

First, a search starting point for departure and a search starting point for a destination are set (Step S101). As shown in FIG. 4, these points are set as a node SN1 (See FIG. 4(a)) on a search target road nearest the place of departure S and a node DN1 (See FIG. 4(b)) on a search target road nearest the destination D. Next, searches are conducted at the lowest hierarchical level for predetermined areas around the departure place (Step S102) and the destination (Steps S103 and S104), respectively, by the Dijkstra method. Various costs are set for each link or node, depending on the road type such as expressway, toll road, national road, main local road, state (or prefecture) road, or narrow street, the existence of traffic restrictions such as no-turns or one-way traffic, link length, width of the road, number of traffic lanes, and so forth. A route is searched from the departure place to the destination by the Dijkstra method, these costs are added, and the route with the lowest cost is obtained, as described below. It is judged whether or not a search area on the departure side and a search area on the destination side overlap (or connect) (Step S105) and, when they do overlap, the route with the lowest cost within the overlapped search area is calculated (Step S106).

Next, when a route with the lowest cost has already been obtained, it is judged whether or not the cost is stored (registered) (Step S107). When it is stored, it is judged whether or not the cost of the newly calculated lowest cost route is smaller than the cost of the stored route with the lowest cost (Step S108). When a route with the (previously) lowest cost is judged to be stored in step S107 and the cost of the newly calculated route with the lowest cost is found in step S108 to be smaller, the stored cost of the route with the lowest cost is updated (Step S109). When the search area on the departure side and the search area on the destination side are judged not to overlap in step S105 and the cost of the newly calculated route with the lowest cost in step S108 is bigger than the stored lowest cost, a judgment is made on terminating the route-searching as described below (Step S110). It is then determined whether or not the judgment has been made in S110 to terminate the route-searching (Step S111) and, when the judgment has not been made to terminate, cost-marking up to an upper level hierarchy is executed as described below (Step S112) and the searching of departure and destination areas proceeds to a higher hierarchical level (Step S113). Next, it is determined whether or not this higher hierarchical level is the highest hierarchical level (Step S114). When the next higher level of data to be searched is not the highest hierarchical level, the sequence returns to step S103 and execution of the search routine is repeated from the departure side in the same way. When the next higher level is the highest hierarchical level, the sequence returns to step S104 and the search routine is repeated from the destination side in the same way. When a judgment has been made in step S111 that the route-searching is terminated, it is then determined whether or not a guidance route has been obtained (Step S115). When a guidance route has not been obtained, the route-searching is judged to be a failure (Step S116). When a guidance route has been obtained, the route is constructed from the result of the route-searching (Step S117) and execution (processing) of the routine is ended.

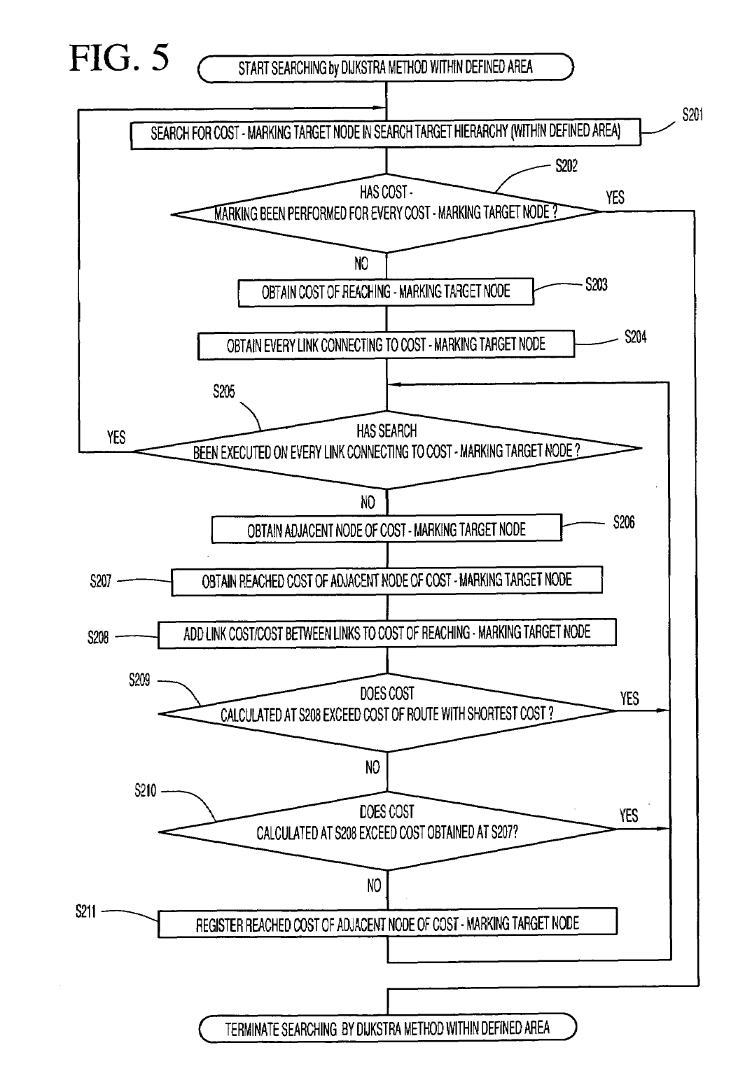

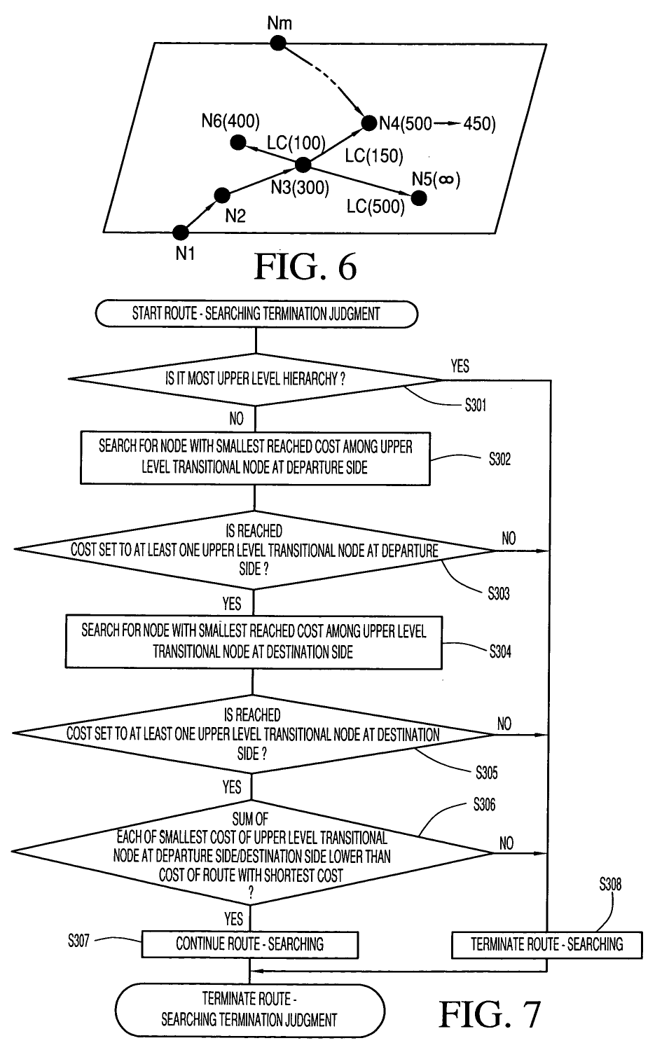

FIG. 5 is a flowchart illustrating a search using the Dijkstra method. A cost-marking target node is searched within a defined area on the departure side and on the destination side on one of the hierarchical levels (step S201). It is then determined whether or not the cost-marking has been performed for all the target nodes (Step S202). When the cost-marking has not been performed for all the target nodes, the cost for reaching the cost-marking target node (“reached cost”) is obtained (Step S203). In FIG. 6, for example, wherein black circles denote cost-marked target nodes in a search target area, a cost-marked target node N3 is a node on a route through nodes N1 and N2 and has a reached cost of 300. Next, every link connecting to the cost-marked target node is obtained (Step S204) and it is determined whether or not a search has been performed on all the obtained links (Step S205). When a search has not been performed on every link, a reached cost of a node adjacent the cost-marked target node is obtained (Step S207). In FIG. 6, for example, N4 is a node adjacent the cost-marked target node N3 and the reached cost 500 is set at the adjacent node N4 on a route through to node Nm. Next, the link cost/the cost between links (the node cost) is added to the reached cost of the cost-marked target node (Step S208) and it is judged whether or not the added cost exceeds the cost of the route with the previously registered (stored) lowest cost (Step S209). When the previously registered lowest cost is not exceeded, it is judged whether or not the cost obtained at step S208 exceeds the reached cost of the adjacent node obtained at step S207 (Step S210). In FIG. 6, for example, the link cost LC to be added to the cost-marked target node N3 is 150 and the reached cost of the adjacent node N4 will be 450 after 150 is added. On the other hand, if the cost of the route with the lowest cost which has been previously obtained is assumed to be 700, the cost of the adjacent node N4, with the link cost LC added to the cost of target node N3, is 450. Note that the 450 cost for adjacent node N4 is smaller than the cost of the route with the previous lowest cost of 700 and further smaller than the reached cost 500 which was previously set at the adjacent node N4. Therefore, the reached cost of the adjacent node N4 will be updated and registered as 450 and the routine returns to step S205 to repeat S205-S209.

In the situation where the cost obtained at step S208 is judged to exceed the registered cost of the route with the lowest cost in step S209 and when the cost obtained at step S208 is judged to exceed the cost of the adjacent node in step S210, the reached cost of the adjacent node which has been already set remains unchanged and the routine returns to step S205 to repeat S205-S209. In FIG. 6, for example, if the link cost LC between the cost-marked target node N3 and the adjacent node N5 is 500, the reached cost of the adjacent node N5 will be 800 which exceeds the cost (700) of the route with the lowest cost which had previously been obtained. Therefore, no further cost-marking is performed and a cost of 0 is set for this node and the routine returns to step S205. The other adjacent node N6 has a link cost LC 100 for the link connecting it with the cost-marked target node N3. When the link cost 100 is added to the 300 cost of N3, 400 is set as the reached cost of node N6. Like processing is sequentially performed in S205 for every other link connected to the cost-marked target node. When the cost-marking is completed in S202 for all the target nodes within the area, the search of the area is terminated.

Referring to FIG. 7, which is a flowchart of a sub-routine for route-searching termination judgment, in S301, it is determined whether or not a search target is in the uppermost hierarchical level of data. When it is not in the uppermost hierarchical level, a search is conducted (S302) for upper level transitional nodes (regional boundary nodes connecting with an adjacent hierarchical level) at the departure side (Step S302) in the current hierarchical level and it is determined whether or not at least one upper level transitional node is set with a reached cost at the departure side (Step S303). Next, a search for the node with the lowest reached cost is searched among upper level transitional nodes (regional boundary nodes) at the destination side (Step S304) in the current hierarchical level and it is determined whether or not at least one upper level transitional node is set with a reached cost at the destination side (Step S305). When the lowest cost upper level transitional node is set at both the departure side and the destination side, in S306 it is determined whether or not the sum of the lowest cost among the upper level transitional nodes at the departure and destination sides is smaller than the cost previously registered as the cost of the lowest cost route. When the sum of the lowest costs of the upper level transitional nodes is smaller than the cost previously registered as the cost of the lowest cost route, the route-search is continued. In the case that a reached cost is not set at steps S303 and S305, the search does not move to an adjacent upper hierarchical level. In the case that the sum of the lowest costs for the upper level transitional nodes at the departure and the destination sides is higher than the cost registered for the route with the lowest cost in step S306, the route-searching is terminated (S308) because no route with a lower cost exists in an upper hierarchical level.

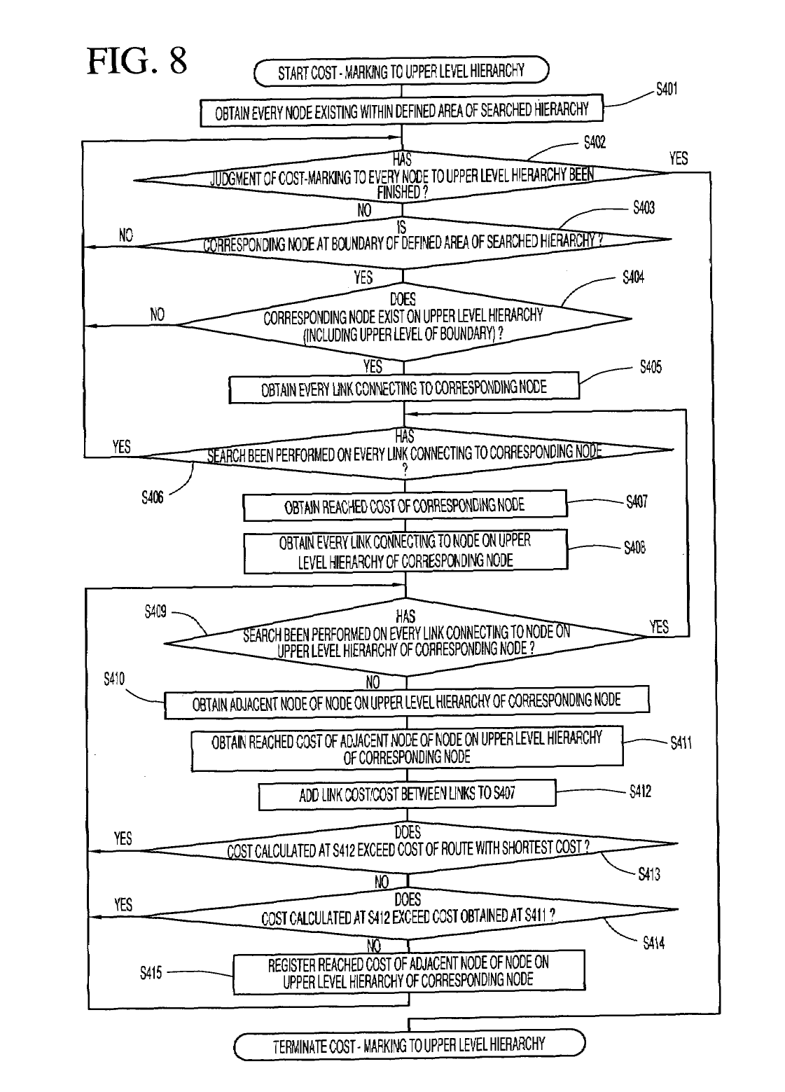

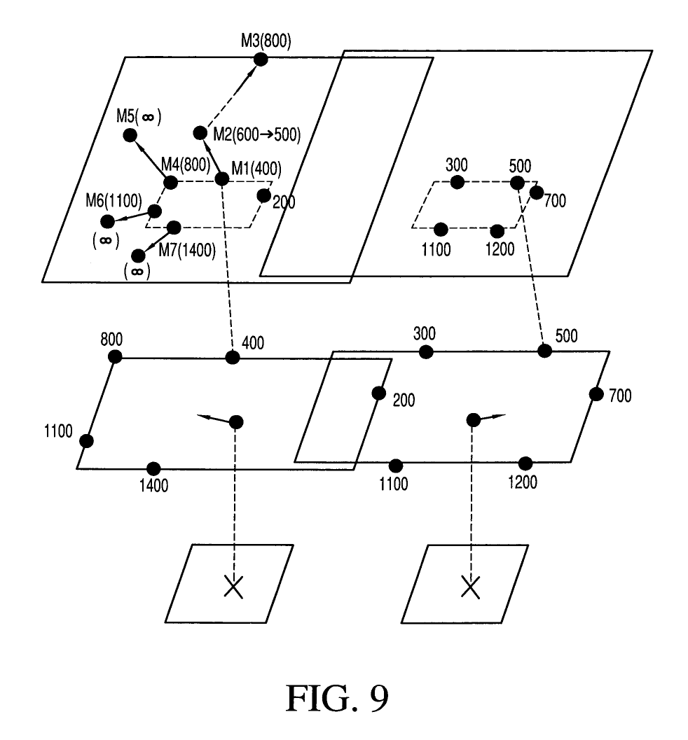

Next, a sub-routine for cost-marking to an adjacent upper hierarchical level will be described with reference to FIG. 8 and FIG. 9. In FIG. 8, every node existing within a defined area of the hierarchical level to be searched is obtained (Step S401). Note that within the searched hierarchical level, cost-marking of every node within the defined area has already been completed by the Dijkstra method. In S402, it is determined whether or not cost-marking of every node in the adjacent upper level has been completed (step S402) and when it has not been completed, it is judged for each node whether or not it is a node at the boundary of the defined area within the searched hierarchical level (Step S403). If it is not a boundary node, the routine returns to step S402 and execution of the routine is continued. In this routine, the nodes for moving to an upper hierarchical level are only boundary nodes. When a node is judged to be a boundary node, it is judged whether or not a corresponding node exists within the defined area on the adjacent upper hierarchical level (including the boundary of the defined area) (Step S404). When no corresponding level exists within the defined area of the upper hierarchical level (including the boundary of the defined area), the search cannot be continued and, therefore, returns to step S402 and continues. If the node is a boundary node and a corresponding node exists on the adjacent upper hierarchical level, every link connecting to the corresponding node on the adjacent upper level is obtained (Step S405) and it is judged whether or not the search has been completed for every link connecting to the upper level corresponding node (Step S406). The search for every link connecting to the boundary node is one step in the search for the route with the lowest cost on the searched hierarchical level. While executing the sub-routine for cost-marking to the adjacent upper hierarchical level, the search for the route with the lowest cost on that hierarchical level is executed in parallel (simultaneously). In the example shown in FIG. 9, the costs of five boundary nodes of the departure side area on the second hierarchical level are 200, 400, 800, 1100, and 1400, respectively, and the costs of five boundary nodes of the destination side are 300, 500, 700, 1100, and 1200, respectively. In the example of FIG. 9, cost-marking at these nodes automatically moves to the upper hierarchical level at the same time a route is searched between the five boundary nodes on the current hierarchical level. Thus, the search for the route with the lowest cost is conducted in parallel with the cost-marking to the adjacent upper hierarchical level.

When the search for every link has not been completed at step S406, a reached cost for the upper level corresponding node is obtained (Step S407) and every link on the adjacent upper level connecting to that node is obtained (Step S408). Next, it is determined whether or not the search has been completed for every link connecting to the corresponding node on the next upper hierarchical level (Step S409). When the search has not been completed on every link, an adjacent node, adjacent the upper level corresponding node, is obtained (Step S410) and the reached cost for that adjacent node is obtained (Step S411). Then, the link costs for the link between the corresponding node and its adjacent node is added to the reached cost of the corresponding node obtained at step S407 (S412) and then it is determined whether or not the sum of costs exceeds the cost of the previously obtained route with the lowest cost obtained at this stage (Step S413). When the new sum does not exceed the previous lowest cost, it is then determined whether or not the summed costs exceed the reached cost of the adjacent node on the adjacent upper hierarchical level (Step S414). If NO in S414, the reached cost of the aforementioned upper level adjacent node is registered/updated (S415) and the sequence returns to step S409 and continues in the same way. In the area of the departure side in FIG. 9, taking node M1 with the cost 400 for example, when the link cost LC between the node M1 and the adjacent node M2 is 100, the cost 400 of the node M1 is added to the link cost 100 to obtain the reached cost 500 for the adjacent node M2. If the cost of the route with the lowest cost previously obtained at this stage is 1000, the reached cost of the adjacent node M2 (500) is less. Assuming, for example, that a reached cost 600 has previously been set for the adjacent node M2 through a search from other side, the reached cost of the adjacent node M2 obtained through the search from the node M1 is smaller and, therefore, the reached cost registered for the adjacent node M2 will be changed (updated) from 600 to 500. In the same manner as described above, cost-marking is performed sequentially to obtain the cost of 800 for the boundary node M3 in the defined area of the upper hierarchical level.

When in S413 the cost calculated at step S412 (the sum of the reached cost of the corresponding upper level node added to the link cost/the cost between links (node)) is judged to exceed the cost of the route with the previously registered lowest cost, no further cost-marking is conducted and the routine returns to step S409 and steps S409-S413 will be repeated in the same way. In the area of the departure side in FIG. 9, taking the node M4 with the reached cost 800 by way of example, if a link LC cost between the node M4 and the adjacent node M5 is 250, the reached cost of the adjacent node M5 is 1050 which exceeds the cost 1000 of the previously determined lowest cost route and, therefore, no further cost-marking is performed and a cost of ∞ is set for the node M5. As for nodes M6 and M7, the cost 1000 for the route with the lowest cost has not been recognized at the time of moving to the upper hierarchical level and, therefore, the costs 1100 and 1400, respectively, are set M6 and M7. However, the reached cost of every node connecting to these nodes exceeds the cost of the previously obtained route with the lowest cost and, therefore, no further cost-marking is conducted and a cost o is set for nodes M6 an M7. In addition, if the cost calculated at step S412 exceeds the reached cost of the adjacent node obtained in step S414, the cost calculated in S412 will not be registered and the routine returns to step S409. Thus, when in S409 it is judged that a search has been completed for every link connecting to the upper level corresponding node and when it has been judged in S402 that the cost-marking for every node in the upper hierarchical level has been completed, the cost-marking to the upper hierarchical level is terminated.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description, and all changes which come within the meaning and range of equivalency of the claims are therefore intended to be embraced therein.

What is claimed is:

1. A navigation apparatus for searching for a route from a departure location to a destination comprising:
an information storage unit storing map data with a hierarchical layered structure;
a route-searching unit that reads out map data structure from the information storage unit, searches for a route within areas predetermined for each of the departure location and the destination on one hierarchical level, and obtains a route with a lowest cost within a range defined by overlapping of the search areas; and
a control unit that controls the searching by the route-searching unit; wherein the control unit updates cost of the obtained route with lowest cost when cost of a route obtained by searching up to a hierarchical level higher than the one hierarchical level obtains a route of lower cost than the cost of a previously obtained route of lowest cost.

2. The navigation apparatus according to claim 1, wherein the route-searching unit registers a cost for reaching each of plural nodes by cost-marking and wherein the control unit controls the route-searching unit to terminate cost-marking for a node when a registered cost of a node reached in the process of searching within a predetermined departure side area or a predetermined destination area side, exceeds the cost of an obtained route with a shortest cost.

3. The navigation apparatus according to claim 1, wherein the route-searching unit registers a cost for reaching each of plural nodes by cost-marking and wherein the control unit terminates route-searching by the route-searching unit when the route-searching reaches a boundary node located at a boundary of the predetermined area on the departure side or on the destination side for which no cost has been registered.

4. The navigation apparatus according to claim 1, wherein the route-searching unit registers a cost for reaching each of plural nodes by cost-marking and wherein the control unit terminates route-searching by the route-searching unit when the route-searching reaches a boundary node located at a boundary of the predetermined area on the departure side or on the destination side having a registered cost which is higher than the cost of a previously obtained lowest cost route.

5. The navigation apparatus according to claim 1, wherein the route-searching unit registers a cost for reaching each of plural nodes by cost-marking and wherein the control unit controls the route-searching unit to terminate cost-marking for a node when a reached cost of an adjacent node of a node on an upper hierarchical level corresponding to a boundary node on a lower hierarchical level exceeds the cost of a previously obtained lowest cost route.

6. A navigation apparatus comprising:
an information storage unit that stores information regarding roads, including a plurality of hierarchical data levels of data with differing degrees of detail within different hierarchical data levels;
a route-searching unit that searches for a route to a destination on the basis of road information stored in the information storage unit, wherein the route-searching unit searches ranges of areas predetermined, respectively, for a departure location and a destination and moves to an upper hierarchical data level with less data detail to continue a route-searching after searching the predetermined ranges; and
a control unit that judges quality of a route obtained by the route-searching unit and controls route-searching processing, wherein the control unit compares cost of a route obtained by searching an upper hierarchical data level and cost of a route obtained by searching a lower hierarchical data level when the routes have been connected between a place of departure and a destination, and terminates the route-searching processing when judging that the cost of a route obtained by searching the lower hierarchical data level is lower than the cost of the route obtained by searching the upper hierarchical data level.

7. A computer-readable medium encoded with a program for controlling a navigation apparatus to search for a route from a place of departure to a destination, and which causes a computer of the navigation apparatus to execute the steps of:
reading out map data with a hierarchical layered structure from an information storage unit;
searching for a route within areas predetermined for each of the place of departure and the destination on one hierarchical level and obtaining a route with a lowest cost for a range in which the search areas overlap; and
updating cost of the obtained route with lowest cost when a cost of a route obtained by searching up to a higher hierarchical level is lower than the cost of the route obtained by search of the one hierarchical level.

8. The navigation apparatus according to claim 1 wherein layers of the hierarchical structure respectively contain data of decreasing detail.

9. The navigation apparatus according to claim 2 wherein layers of the hierarchical structure respectively contain data of decreasing detail.

10. The navigation apparatus according to claim 3 wherein layers of the hierarchical structure respectively contain data of decreasing detail.

11. The navigation apparatus according to claim 4 wherein layers of the hierarchical structure respectively contain data of decreasing detail.

12. The navigation apparatus according to claim 5 wherein layers of the hierarchical structure respectively contain data of decreasing detail.

13. The navigation apparatus according to claim 1 wherein the route-searching unit searches for the lowest cost route on the one hierarchical level while simultaneously cost-marking by registering a cost for reaching each of plural nodes on an upper level adjacent the one hierarchical level.

14. The navigation apparatus according to claim 2 wherein the route-searching unit searches for the lowest cost route on the one hierarchical level while simultaneously cost-marking by registering a cost for reaching each of plural nodes on an upper level adjacent the one hierarchical level.

15. The navigation apparatus according to claim 3 wherein the route-searching unit searches for the lowest cost route on the one hierarchical level while simultaneously cost-marking by registering a cost for reaching each of plural nodes on an upper level adjacent the one hierarchical level.

16. The navigation apparatus according to claim 4 wherein the route-searching unit searches for the lowest cost route on the one hierarchical level while simultaneously cost-marking by registering a cost for reaching each of plural nodes on an upper level adjacent the one hierarchical level.

17. The navigation apparatus according to claim 5 wherein the route-searching unit searches for the lowest cost route on the one hierarchical level while simultaneously cost-marking by registering a cost for reaching each of plural nodes on an upper level adjacent the one hierarchical level.

18. The navigation apparatus according to claim 6 wherein the route-searching unit searches for the lowest cost route on the one hierarchical level while simultaneously cost-marking by registering a cost for reaching each of plural nodes on an upper level adjacent the one hierarchical level.

19. The computer readable medium according to claim 7 wherein layers of the hierarchical structure respectively contain data of decreasing detail.

20. The computer readable medium according to claim 7 wherein the encoded program further causes the computer to search for the lowest cost route on the one hierarchical level while simultaneously cost-marking by registering a cost for reaching each of plural nodes on an upper level adjacent the one hierarchical level.
